(19) United States
(12) Patent Application Publication
(10) Pub. No.: US 2020/0406861 A1
(43) Pub. Date: Dec. 31, 2020

(54) ON-VEHICLE SENSOR CLEANING DEVICE

(71) Applicant: DENSO CORPORATION, Kariya-city (JP)

(72) Inventors: Eiji INA, Kariya-city (JP); Keita SAITO, Kariya-city (JP)

(73) Assignee: DENSO CORPORATION, Kariya-city (JP)

(21) Appl. No.: 16/909,225

(22) Filed: Jun. 23, 2020

(30) Foreign Application Priority Data
Jun. 25, 2019 (JP) 2019-117086

(51) Int. Cl. B60S 1/08; B60S 1/52; B60S 1/54

(52) U.S. Cl. CPC B60S 1/0833; B60S 1/544; B60S 1/522

(57) ABSTRACT

An on-vehicle sensor cleaning device includes a cleaning actuator that cleans a cleaning object surface an on-vehicle sensor, the cleaning object surface being cleaned by operating the actuator; and a controller that drives the cleaning actuator when fouling degree information of the cleaning object surface reaches a fouling threshold. The controller is configured to change the fouling threshold depending on a vehicle speed information.

### CROSS-REFERENCE TO RELATED APPLICATION

This application is based on and claims the benefit of priority from earlier Japanese Patent Application No. 2019-117086 filed Jun. 25, 2019, the description of which is incorporated herein by reference.

### BACKGROUND

### Technical Field

The present disclosure relates to an on-vehicle sensor cleaning device.

### Description of the Related Art

Conventionally, some vehicle is equipped with an on-vehicle sensor cleaning device together with an on-vehicle sensor. As an on-vehicle sensor cleaning device, the device includes a nozzle, a wiper, a sensor and a controller.

### SUMMARY

The present disclosure provides an on-vehicle sensor cleaning device including: a cleaning actuator that cleans a cleaning object surface an on-vehicle sensor, the cleaning object surface being cleaned by operating the actuator; and a controller that drives the cleaning actuator when fouling degree information of the cleaning object surface reaches a fouling threshold. The controller is configured to change the fouling threshold depending on a vehicle speed information.

### BRIEF DESCRIPTION OF THE DRAWINGS

In the accompanying drawings:

FIG. 1 is a schematic diagram showing a sensor system according to an embodiment of the present disclosure;

FIG. 2 is a graph showing time-detection accuracy characteristics used for explaining an operation of an on-vehicle sensor cleaning device according to the embodiment; and

FIG. 3 is flowchart showing a threshold setting process of the on-vehicle sensor cleaning device.

### DETAILED DESCRIPTION OF THE PREFERRED EMBODIMENTS

As a conventional on-vehicle sensor cleaning device, for example, Japanese Patent Application Laid-Open Publication Number 1993-14961 discloses an on-vehicle sensor cleaning device including a nozzle that jets a cleaning liquid onto an object surface to be cleaned in the on-vehicle sensor, a wiper that wipes the object surface, a fouling detection sensor that detects fouling on the object surface, and a controller that controls jetting of the cleaning liquid and driving of the wiper in response to a signal transmitted from the fouling detection sensor. According to such an on-vehicle sensor cleaning device, the device is able to automatically clean the object surface depending on a degree of fouling on the object surface.

However, according to the above-mentioned on-vehicle sensor cleaning device, the device merely cleans the object surface depending on a degree of fouling on the object surface. Hence, the device may excessively clean the object surface even if cleaning is not actually required. In this case, the device often drives a liquid pump that supplies the cleaning liquid to the nozzle and a cleaning actuator such as an actuator that drives a wiper more than necessary, and thus causing an increase in the power consumption and a degradation of durability of the cleaning actuator.

Hereinafter, with reference to the drawings, embodiments of the present disclosure in light of the above-described circumstances will be described.

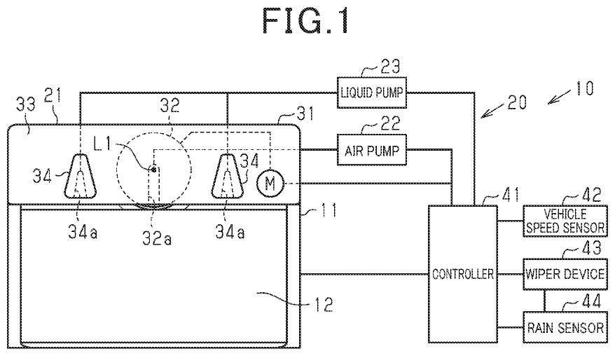

With reference to FIGS. 1 to 3, an embodiment of a sensor system will be described.

As shown in FIG. 1, a sensor system 10 according to the present embodiment is provided with an on-vehicle sensor 11, and an on-vehicle sensor cleaning device 20 integrated with the on-vehicle sensor 11. The on-vehicle sensor cleaning device is configured to clean an optical surface as a cleaning object surface of the on-vehicle sensor 11.

The on-vehicle sensor 11 according to the present embodiment serves, for example, as a LIDAR (i.e. laser detection and ranging) in which an infrared laser is emitted and scattered light which is reflected at an object is received to measure the distance to the object, and includes an optical surface 12 through which the laser light passes. The on-vehicle sensor 11 measures a distance to the object by using an infrared laser and outputs the measured information to an external equipment. The on-vehicle sensor 11 can be used for an automatic braking system.

The on-vehicle sensor cleaning device 20 is provided with a nozzle unit 21 stuck above the on-vehicle sensor 11, air pump 22 that supplies air to the nozzle unit 21, and a liquid pump 23 that supplies a cleaning liquid to the nozzle unit 21.

The nozzle unit 21 is provided with a casing 31 fixed to above the on-vehicle sensor 11, a movable nozzle 32 provided in which a part of the nozzle is exposed from the casing 21, and a motor M disposed inside the casing 31. The movable nozzle 32 includes a jet port 32a that jets the air supplied from the air pump 22 towards the optical surface 12. The movable nozzle 32 is configured to be rotatable with respect to a rotary axis L1 which is along a direction orthogonal to the optical surface 12 so as to change the direction of the jet port 32a, that is, direction of the air jet. The motor M is drive-coupled with the movable nozzle 32 to be capable of driving the movable nozzle 32, that is, rotating the movable nozzle. According to the present embodiment, the air pump 33 and the motor M each constitutes the cleaning actuator. The nozzle unit 21 includes a cover 33 that covers a front side (front side when viewed on a paper in FIG. 1) of the movable nozzle 32 to which a pair of liquid jet nozzles 34 is fixed. The liquid jet nozzle 34 includes a liquid jet port 34a that jets the cleaning liquid supplied from the liquid pump 23 to the optical surface 12.

Further, the on-vehicle sensor cleaning device 20 is provided with a controller 41 that drives the air pump 22 and the motor M when the fouling degree information of the optical surface 12 reaches a threshold HL (i.e. fouling threshold HL). The controller 41 is configured to change the threshold HL depending on the vehicle speed information.

Specifically, for the controller 41, the on-vehicle sensor 11, the air pump 22, the liquid pump 23, the motor M, a vehicle speed sensor 42, a wiper device 43, a rain sensor 44 are electrically connected directly or indirectly to the controller 41. Note that the wiper device 43 is driven in accordance with rain information detected by the rain sensor 44 or driven by an operation of a wiper switch which is not shown, and wipes windshield. The controller 41 accepts detection accuracy data based on information of the intensity of received light from the on-vehicle sensor 11, and utilizes the detection accuracy data as the fouling degree information of the optical surface 12. Note that the maximum value of the detection accuracy data is set to be 100 which is data representing the highest detection accuracy and the lowest degree of fouling. The controller 41 drives the air pump 22 and the motor M when the detection accuracy data reaches the threshold HL, that is, the detection accuracy data is lower than or equal to the threshold HL. Moreover, the controller 41 drives the liquid pump 23 when the detection accuracy data reaches the liquid jet threshold L, that is, the detection accuracy data is lower than or equal to the threshold L. The controller 41 terminates the cleaning when the detection accuracy data becomes larger than or equal to the cleaning end threshold HH after starting the cleaning.

The controller 14 of the present embodiment changes the threshold HL depending on the vehicle speed information transmitted from the vehicle speed sensor 42 and weather information transmitted from the wiper device 43. Specifically, the controller 41 sets the threshold HL to be larger value when the vehicle speed is higher than the predetermined reference speed such that the detection accuracy data reaches the threshold earlier than the case where the vehicle speed is lower than or equal to the reference speed. Also, the controller 41 sets the threshold HL to be larger such that the higher amount of rain falling is detected, the larger value is set. In other words. the controller 41 changes, when the wiper device 43 operates in a high speed driving mode, the threshold HL to be larger than that of a low speed driving mode, such that the detection accuracy data reaches the threshold earlier than the case of the low speed driving mode. The controller 41 changes, when the wiper device 43 operates in the low speed driving mode, the threshold HL to be larger than that of a stop mode, such that the detection accuracy data reaches the threshold earlier than the case of stop mode.

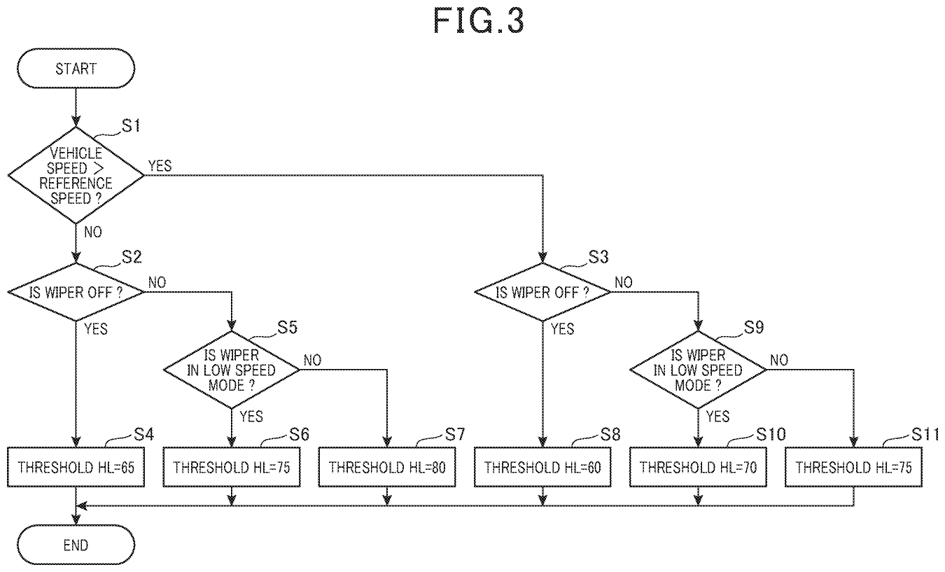

Specifically, as shown in FIG. 3, the controller 41 repeatedly executes a threshold setting process to set the threshold HL during a travelling state of the vehicle or a travel preparation state of the vehicle. The controller 41 determines, at step S1, whether the travelling speed is higher than the predetermined reference speed, and proceeds to step 2 when determines that the travelling speed is higher than the predetermined reference speed, and proceeds to step S4 when determined that travelling speed is not higher than the predetermined reference speed.

When the controller 41 determines the wiper device 43 is in stopped state at step S2, the process proceeds to step S4. When the controller 41 determines that the wiper device 43 is not in the stop state, the process proceeds to step S5. The controller 41 sets the threshold HL to be 65 and terminates the process.

Further, the controller 41 determines whether the wiper device 43 is in a low speed driving mode at step S5, and proceeds to step S6 when determined that the wiper device 43 is in a low speed driving mode. When the controller 41 determines that the wiper device 43 is not in the low speed driving mode, that is, in the high speed driving mode, the process proceeds to step S7. The controller 41 sets the threshold HL to be 75 at step S6 and terminates the process. Further, the controller 41 sets the threshold HL to be 80 at step S7 and terminates the process.

On the other hand, at step S1, when determined that the vehicle speed is not higher than the predetermined reference speed, the controller 41 determines whether the wiper device is in stop state at step S3, and the process proceeds to step S8 when determined that the wiper device 43 is in stop state, and the process proceeds to step 9 when determined that the wiper device 43 is not stop state. Then, the controller 41 sets the threshold HL to be 60 at step S8 and terminates the process.

The controller 41 determines whether the wiper device 43 is in a low speed driving mode at step S9. When determined that the wiper device 43 is in low speed driving mode, the process proceeds to step S10, and when determined that the wiper device 43 is not in the low speed driving mode, that is, in high speed driving mode, the process proceeds to step S11. Then, the controller 41 sets the threshold HL to be 70 at step S10 and terminates the process. Moreover, the controller 41 sets the threshold to be 75 at step S11 and terminates the process.

Also, the above-described threshold HL is always set to be larger than the liquid jet threshold L regardless of the vehicle speed information and the weather information such that the detection accuracy data reaches the threshold HL earlier than the liquid jet threshold L. Further, the above-described threshold HL is set to be smaller than the cleaning end threshold HH regardless of the vehicle speed information and the weather information. Specifically, for example, the liquid jet threshold L is set to be 50, the cleaning end threshold HH is set to be 85, and the above-described threshold HL is set to be in a range from 60 to 80.

Next, effects and advantages of the sensor system 10 as configured above will be described. For example, when the vehicle is running, the on-vehicle sensor 11 operates whereby an object ahead of the vehicle and the distance to the object is recognized.

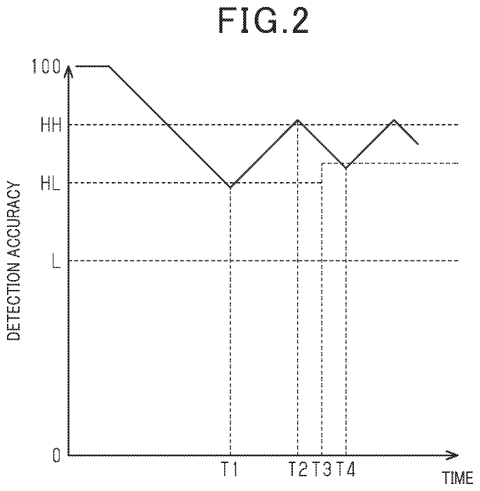

For example, in the case where the vehicle speed is lower than or equal to the reference speed and the wiper device 43 is in a low speed driving state, the threshold HL is set to be 70 by the threshold setting process. Then, as shown in FIG. 2, in the case where foreign matters such as raindrops or the like are adhered to the optical surface 12 to cause a decrease in the detection accuracy data, and the detection accuracy data reaches the threshold HL at the timing T1, that is, the threshold value 70, the controller drives the air pump 22 and the motor M.

Then, the movable nozzle 32 jets, while being rotated, the air from the jet port 32a of the movable nozzle 32, and the jet air cleans the optical surface 12. Thereafter, when the detection accuracy data becomes the cleaning end threshold HH or larger at the timing T2, the controller stops operation of the air pump 22 and the motor M.

Moreover, for example, in the case where the vehicle speed is higher than the reference speed at timing T3 and the wiper device 43 is in low speed driving mode, the threshold setting process changes the threshold to be 75. Thereafter, when the detection accuracy data decreases by adhesion of foreign matters such as rain drops on the optical surface 12, and reaches the threshold HL, that is, 75 at the timing T4, the controller 41 drives the air pump 22 and the motor M.

Then, the movable nozzle 32 jets, while being rotated, the air from the jet port 32a of the movable nozzle 32, and the jet air cleans the optical surface 12. Thus, the optical surface 12 is cleaned based on the detection accuracy data while the threshold HL is changed depending on the vehicle speed information and the weather information.

Further, for example, in the case where the detection accuracy data further decreases to reach the liquid jet threshold L, that is, threshold value 50, the controller 41 drives the liquid pump 23 to jet the cleaning liquid from the liquid jet port 34a of the liquid jet nozzle 34, thereby cleaning the optical surface.

Hereinafter, effects and advantages of the present embodiment will be described.

1) the controller 41 drives the air pump 22 and the motor M when the detection accuracy data reaches the threshold HL. Since the controller 41 changes the threshold HL depending on the vehicle speed information, the air pump 22 and the motor M are operated based on the vehicle speed information the cleaning operation can be performed as needed. In other words, for example, in the case where the vehicle speed is lower than or equal to the reference speed so that high detection accuracy is not required to be maintained, the threshold HL is set to be lowered. Hence, excessive cleaning operations can be suppressed. Accordingly, low power consumption of the device can be accomplished and the durability of the air pump 22 and the motor M can be improved.

2) the liquid pump 23 is provided to jet the cleaning liquid onto the optical surface 12, since the controller 41 drives the liquid pump 23 when the detection accuracy data reaches the liquid jet threshold L, the optical surface 12 can be cleaned with jetting of the cleaning liquid when the detection accuracy data reaches the liquid jet threshold L. Since the threshold HL is set such that the detection accuracy data reaches earlier than a case where the detection accuracy data reaches the liquid jet threshold L, when the optical surface becomes in fouling state, the optical surface 12 can be cleaned first by the jetting of the air. Thus, in the case where the fouling can be cleaned by jetting of the air, consumption of the cleaning liquid as a consumption material can be suppressed.

3) since the controller 41 changes the threshold HL depending on not only with the vehicle speed information but also the weather information, the air pump 22 and the motor M are operated depending on the vehicle speed information and the weather information, whereby the cleaning operation can be performed at appropriate timing as needed.

4) since the weather information is an operating state of the wiper device 43, dedicated sensor acquiring the weather information is not required.

5) since the detection accuracy data obtained from the on-vehicle sensor 11 can be utilized as the fouling degree information of the optical surface 12, dedicated sensor acquiring the fouling degree information is not required.

The above-described embodiments can be modified in the following manners. Also, the present embodiment and following modifications can be mutually combined as long as they are technically consistent. According to the present embodiment, the air pump 22 and the motor M are configured as the cleaning actuator which is driven in accordance with the detection accuracy data being reached the threshold HL. It is not limited this configuration, but another cleaning actuator can be utilized.

For example, for the on-vehicle sensor cleaning device in which the movable nozzle 32 is not provided and jet port is fixed, only the air pump 22 may be utilized as the cleaning actuator. Also, the liquid pump 23 as the cleaning actuator may be used in addition to the air pump 22. That is, the controller 41 may be configured to change the liquid jet threshold L together with the threshold HL depending on the vehicle speed information. In such case, the on-vehicle sensor cleaning device may be configured such that the cleaning liquid and the air are mixed and the mixed liquid is jet onto the optical surface 12.

For example, for the on-vehicle sensor cleaning device in which the air pump 22 is not provided, the liquid pump 23 may be utilized as the cleaning actuator. Moreover, for the on-vehicle sensor cleaning device provided with a sensor wiper for wiping the optical surface 12 and a sensor wiper driving device that drives the sensor wiper, the cleaning actuator may be utilized for the sensor wiper driving device.

According to the above-described embodiment, the on-vehicle sensor cleaning device provided with the liquid pump 23 and the liquid jet port 34a is used. However, it is not limited thereto. Alternatively, an on-vehicle sensor cleaning device without the liquid pump 23 and the liquid jet port 34a may be utilized.

According to the above-described embodiment, the controller 41 is configured to change the threshold HL depending on not only the vehicle speed information but also the weather information. It is not limited thereto. The controller 41 may change the threshold HL regardless of the weather information.

According to the above-described embodiment, the weather information is determined based on operating state of the wiper device 43. However, it is not limited thereto. For example, a dedicated sensor may be utilized as an alternative for acquiring the weather information. The wiper device 43 is configured to operate in accordance with rainfall information detected by the rain sensor 44 or an operational state of a wiper switch which is not shown, and the operational state is used as the weather information. However, it is not limited thereto. For example, a signal acquired by the rain sensor 44 may be used as the weather information regardless of the operational state of the wiper device 43. Further, in the case where the rain sensor 44 is not provided, a signal responding to a state of the wiper switch may be used.

According to the above-described embodiment, the detection accuracy data of the on-vehicle sensor 11 is used as the fouling degree information of the optical surface 12. For example, a dedicated sensor for acquiring the fouling degree information may be utilized as an alternative.

According to the above-described embodiment, the controller 41 is configured to change the threshold HL with two steps for the vehicle speed information and with three steps for the weather information. However, it is not limited thereto. For the vehicle speed information, three or more steps may be used for the vehicle speed information, and two steps or four or more steps may be used for the weather information, or the threshold HL may be changed steplessly for the vehicle speed information and the weather information.

According to the above-described embodiment, LIDAR is used as the on-vehicle sensor 11. However, other on-vehicle sensors may be utilized. Further, according to the above-described embodiment, the object surface to be cleaned is the optical surface 12 of the LIDAR, but another object surface to be cleaned may be utilized for other on-vehicle sensor.

### CONCLUSION

The present disclosure provides an on-vehicle sensor cleaning device capable of cleaning a sensor of vehicle as needed. The present disclosure provides an on-vehicle sensor cleaning device including: a cleaning actuator (22, M) that cleans a cleaning object surface (12) an on-vehicle sensor (11), the cleaning object surface being cleaned by operating the actuator; and a controller (41) that drives the cleaning actuator when the fouling degree information of the cleaning object surface reaches a fouling threshold (HL). The controller (41) is configured to change the fouling threshold depending on a vehicle speed information.

According to this configuration, the controller changes the fouling threshold depending on the vehicle speed information, whereby the sensor cleaning can be performed as needed. Thus, low power consumption of the device can be accomplished and the durability of the cleaning actuator can be improved.

What is claimed is:

1. An on-vehicle sensor cleaning device comprising:
a cleaning actuator that cleans a cleaning object surface of an on-vehicle sensor, the cleaning object surface being cleaned by operating the actuator; and
a controller that drives the cleaning actuator when fouling degree information of the cleaning object surface reaches a fouling threshold,
wherein
the controller is configured to change the fouling threshold depending on vehicle speed information.

2. The on-vehicle sensor cleaning device according to claim 1, wherein
the cleaning actuator includes an air pump that jets air onto the cleaning object surface.

3. The on-vehicle sensor cleaning device according to claim 2, further comprising:
a jet port that jets the air supplied from the air pump towards the cleaning object surface; and
a movable nozzle capable of capable of changing a direction of the jet port,
wherein
the cleaning actuator includes a motor for driving the movable nozzle.

4. The on-vehicle sensor cleaning device according to claim 2, further comprising a liquid pump that jets a cleaning liquid onto the cleaning object surface,
wherein
the controller is configured to drive the liquid pump when the fouling degree information reaches a liquid jet threshold; and
the fouling threshold is set such that the fouling degree information reaches the fouling threshold earlier than a case where the fouling degree information reaches the liquid jet threshold.

5. The on-vehicle cleaning device according to claim 1, wherein
the controller is configured to change the fouling threshold depending on the vehicle speed information and weather information.

6. The on-vehicle cleaning device according to claim 5, wherein
the weather information is a driving mode of a wiper device.

7. The on-vehicle cleaning device according to claim 1, wherein
the fouling degree information is the detection accuracy data of the on-vehicle sensor.
